(19) United States
(12) Patent Application Publication
(10) Pub. No.: US 2025/0291166 A1
(43) Pub. Date: Sep. 18, 2025

(54) Multimodal Microscope and Microscopy Method

(71) Applicant: Carl Zeiss Microscopy GmbH, Jena (DE)

(72) Inventors: Joerg Siebenmorgen, Jena (DE); Richard Hollinger, Jena (DE); Ralf Netz, Jena (DE)

(21) Appl. No.: 19/078,474

(22) Filed: Mar. 13, 2025

(30) Foreign Application Priority Data
Mar. 13, 2024 (DE) 10 2024 107 203.2

(51) Int. Cl. G02B 21/00

(52) U.S. Cl. CPC G02B 21/0032; G02B 21/0076; G02B 21/008

(57) ABSTRACT

A multimodal microscope having a light source for transmitting excitation light, an illumination beam path with a microscope objective for guiding the excitation light onto and/or into a sample a first spatial light modulator arranged in or near a pupil plane of the illumination beam path and a second spatial light modulator arranged in or near an intermediate image plane of the illumination beam path downstream of the pupil plane, a controller at least configured to control the first and/or the second spatial light modulator for realizing an illumination mode for the sample. The controller is configured to control the second spatial light modulator outside a desired illumination region for representing a grating, the period of which is chosen such that excitation light of the +1st and/or −1st order of diffraction lies in at least one pupil plane outside a region through which there is propagation as far as the sample.

The current application claims the benefit of German Patent Application No. 10 2024 107 203.2, filed on 13 Mar. 2024, which is hereby incorporated by reference.

The present invention relates in a first aspect to a multimodal microscope according to the preamble of claim 1 and in a second aspect to a method for microscopy according to the preamble of claim 18.

A generic multimodal microscope has at least the following component parts: a light source for transmitting excitation light, an illumination beam path having a microscope objective for guiding the excitation light onto and/or into a sample to be examined, a detector for detecting detection light emitted by the sample owing to illumination with the excitation light, a detection beam path, comprising the microscope objective or a further microscope objective, for guiding the detection light onto the detector. In the illumination beam path a first spatial light modulator is arranged in or near a pupil plane of the illumination beam path and a second spatial light modulator is arranged in or near an intermediate image plane of the illumination beam path. Finally, a controller is present, which is configured at least for controlling the first spatial light modulator and the second spatial light modulator and is additionally configured to control the first spatial light modulator and/or the second spatial light modulator for the purpose of realizing an illumination mode for the sample.

In a generic method for microscopy, at least the following method steps are carried out: excitation light is guided onto and/or into a sample to be examined, via an illumination beam path with a microscope objective, detection light emitted by the sample owing to illumination with the excitation light is guided onto a detector via the microscope objective or a further microscope objective and is detected by said detector, the excitation light is guided initially via a first spatial light modulator arranged in or near a pupil plane of the illumination beam path and subsequently via a second spatial light modulator arranged in or near an intermediate image plane of the illumination beam path, and the excitation light is modulated by the first and/or the second spatial light modulator for the purpose of realizing an illumination mode for the sample.

Generic microscopes and generic methods are known in many configurations and variants, for example from DE 10 2022 103 051 A1.

There are various approaches for implementing optical manipulators. By way of example, a point scanner can be regarded as an optical manipulator. That involves defining a region in the sample on which light is intended to impinge. This region is then scanned by means of a focused laser. The scan of the laser spot requires a certain time. The larger the region, the longer the duration of the scan. Scans may take up a few 100 ms. In other words, an instantaneous illumination of all points of the sample is not possible. One advantage, however, since the entire laser light is concentrated at a focus point, is that the sample can be illuminated with a high intensity [RAPP0].

Another approach consists in using spatial light modulators for beam shaping. Various possibilities for manipulating the excitation light arise depending on whether a spatial light modulator is arranged in a pupil plane or in an intermediate image plane.

Spatial light modulators (SLM=Spatial Light Modulator) encompass devices which can vary a phase and/or an amplitude of incident light in a location-dependent manner in the beam cross section. This can be done individually for each point in the beam cross section. Spatial light modulators can have for example 1920×1080 elements on a chip diagonal of one to two centimetres. In the case of ferroelectric spatial light modulators, comparatively high repetition rates of several kHz are possible, but they are inefficient with a luminous efficiency of only approximately 5%. In the case of nematic spatial light modulators, although only repetition rates of 60 Hz to 180 Hz are possible, luminous efficiencies of up to 80% can be achieved. In this case, the term luminous efficiency denotes the ratio between the light incident on the respective spatial light modulator and the light shaped by this light modulator.

Also known are arrangements in which a first spatial light modulator is arranged in an intermediate image plane and, downstream thereof, a further spatial light modulator is arranged in a pupil plane [Jes08]. Using phase-modulating spatial light modulators, such set-ups make it possible to manipulate both phase and amplitude of the excitation light.

[US001] describes an arrangement in which firstly a spatial light modulator is arranged in a pupil plane and, downstream thereof, a DMD (DMD=Digital Mirror Device) is then arranged in an intermediate image plane. The DMD is used, inter alia, to direct away unwanted light as a result of inclination of sub-mirrors. This makes it possible to reduce higher orders, so-called ghost images and background light.

Pixelated two-dimensional spatial light modulators have the advantage that the entire illumination pattern is instantaneously radiated in. Scanning of the illumination pattern, for example in the form of one or more illumination spots, is no longer necessary. Because the laser power is distributed simultaneously over a large area, however, the light intensities attainable at the respective sample location are not as high as in the case of a scanning system.

A control pattern for a spatial light modulator in a pupil plane which allows a desired illumination pattern to be attained in an intermediate image plane and sample plane can be obtained for example using the Gerchberg-Saxton algorithm [Ger72], [Rei99], [Sim14].

That involves employing an iterative method to calculate phase patterns which upon a given illumination on a spatial light modulator are represented in the pupil plane and then generate the desired illumination pattern in a subsequent intermediate image plane.

Intermediate image and pupil are linked with one another by way of a Fourier transformation in a fundamentally known manner. In principle, any desired patterns, including three-dimensional patterns, can be generated, although the computational complexity is considerable.

Furthermore, so-called superposition algorithms are known. If multiple points are generated in two or three dimensions, a hologram consisting of in each case a lateral translation term (blazed grating) and an axial defocus term (Fresnel lens) can be created for each point. All the holograms are added in the form of complex vector amplitudes. From the total amplitude, the phase is then extracted and used further. This phase is represented on the spatial light modulator arranged in the pupil plane. This algorithm has comparatively low computational complexity [Rei99].

Finally, in the case of the so-called phase grating method, a desired intensity distribution is generated by a procedure in which the optical plane of the spatial light modulator in the pupil plane or of the spatial light modulator in the intermediate image plane is areally illuminated and then a phase grating diffracts only the respectively desired intensity distribution over the optical axis. This can be achieved by means of an amplitude modulation of the phase grating. By way of example, in [Dav99] a blazed grating is used as a phase grating. At those positions at which the phase grating has an amplitude of 2π, 100% of the light is diffracted. At positions with an amplitude smaller than 2π, only a smaller proportion of the light is diffracted in each case. Non-diffracted light can be filtered out by a stop. By way of example, a binary grating is used in [Nak19]. The binary grating works in a similar manner to a blazed grating, with the difference that the amplitude has a phase deviation of π at maximum diffraction efficiency. Related methods of modulating the amplitude of the phase deviation in the grating may be found in [Cla16], for example. These methods are usually applied in the intermediate image. Application in a pupil is possible, but ineffective.

An object of the invention can be considered that of providing a multimodal microscope and specifying a method for microscopy which can be used for many different microscopic methods and make it possible to generate various illumination modes with high quality.

This object is achieved by means of the multimodal microscope having the features of claim 1 and by means of the method having the features of claim 18.

Preferred exemplary embodiments of the microscope according to the invention and advantageous variants of the method according to the invention are explained below, in particular with reference to the dependent claims and the appended figures.

The multimodal microscope according to the invention can be configured in particular for carrying out the method for microscopy according to the invention. The method according to the invention can be carried out in particular by the multimodal microscope according to the invention.

According to the invention, the multimodal microscope of the type specified above is developed further in that the controller is configured to control the second spatial light modulator outside a desired illumination region for the purpose of representing a grating, the period of which is chosen such that excitation light of the +1st and/or of the −1st order of diffraction lies in at least one pupil plane outside a region through which there is propagation as far as the sample.

According to the invention, the method of the type specified above is developed further in that the second spatial light modulator is controlled outside a desired illumination region for the purpose of representing a grating, the period of which is chosen such that excitation light of the +1st and/or of the −1st order of diffraction lies in at least one pupil plane outside a region through which there is propagation as far as the sample.

If beam shaping is carried out on the first spatial light modulator in the pupil plane, for example with a phase pattern, a desired intensity distribution arises on the second spatial light modulator in the intermediate image plane. Inaccuracies in the optical set-up and in the calibration of the first spatial light modulator, and/or inaccuracies, in particular discretization errors, when generating and representing a pattern used to control the first spatial light modulator can have the effect that a portion of the excitation light coming from the first spatial light manipulator is incident on the second spatial light modulator outside an intended region.

A basic concept of the present invention can now be considered that of combating such inaccuracies by virtue of a grating being represented by means of the second spatial light modulator in the regions outside an intended illumination region, the period of which grating is chosen such that the light diffracted at this grating cannot be propagated as far as the sample by the further illumination beam path.

The accuracy of the illumination patterns can be increased in the case of the microscope according to the invention and with the method according to the invention. In particular, it is possible to attain a lower intensity background in the sample for many illumination modes.

The present invention provides a multimodal microscope whose illumination beam path realizes a very flexible illumination unit and which is suitable, in principle, for generating any desired illumination modes for a sample. Changing between different illumination modes is possible without a high outlay or complexity in this case.

As a light source for the microscope according to the invention, in essence lasers are conceivable, but other light sources are also possible. The excitation light is electromagnetic radiation preferably in the visible range and adjoining ranges. With regard to the samples to be examined, there is no restriction, in principle. The samples to be examined will often be biological samples.

The term illumination beam path denotes all optical beam-guiding and beam-modifying components, for example a microscope objective, lenses, mirrors, prisms, gratings, filters, stops, beam splitters, modulators, for example spatial light modulators (SLM), by means of which and via which the excitation light from the light source is guided to the sample to be examined. Beam-modifying components also encompass dispersive and in particular diffractive elements. Commercially available microscope objectives can be used, in principle.

Detection light is electromagnetic radiation emitted by the sample illuminated with the excitation light. Emitting means that detection light comes from the sample. The detection light can be reflected back from the sample or can be light which is transmitted through the illuminated sample. The detection light can typically be, in comparison with the excitation light, red-shifted fluorescent light from fluorescent markers used to prepare the sample.

Commercially available detectors can be used as detectors. Particularly preferably, semiconductor detectors are used. The detector can be in particular a two-dimensionally spatially resolving detector, thus a camera, for example a CCD, CMOS or SPAD array camera. However, for specific microscopy techniques, for example those in which an illumination point or an illumination line is scanned over or through the sample, it is possible to use a punctiform detector, for example a photomultiplier, or a linear detector, for example a CCD or CMOS line array or a linear SPAD array.

The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy and for reflected-light microscopy in which the sample is illuminated and observed obliquely (as in light sheet microscopy, for example).

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

The period of the grating to be represented by the second spatial light modulator according to the invention can be chosen in particular such that excitation light of the +1st and −1st orders of diffraction lies in the back focal plane of the microscope objective outside a pupil.

The term pupil is taken to mean that cross-sectional region in the back focal plane of the microscope objective which represents the region of the narrowest constriction of the beam of rays that comes from the sample or is incident on the sample.

The term controller denotes all hardware and software components which interact with the components of the microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The controller can have in particular customary operating devices and peripherals, such as mouse, keyboard, screen, storage media, joystick, Internet connection. The controller can in particular read the image data from the detector and can also be configured and serve to control the light source. According to the invention, the controller is at least configured to control the first spatial light modulator and second spatial light modulator. If further spatial light modulators are present, the control unit can expediently also be configured for controlling these further light modulators.

In one particularly preferred configuration, the first spatial light modulator can be formed by a first sub-region of a spatial light modulator, and the second spatial light modulator can be formed by a second sub-region of the same spatial light modulator.

In principle, it is possible for at least one, a plurality or each of the components of first spatial light modulator, second spatial light modulator, spatial light modulator, to be formed by an amplitude-modulating spatial light modulator. It is advantageous, however, if at least one, a plurality or each of the components of first spatial light modulator, second spatial light modulator, spatial light modulator, is or are formed by a phase-modulating spatial light modulator. Phase-modulating spatial light modulators are preferred in general owing to the smaller light losses.

Then at least one, a plurality or each of the components of first spatial light modulator, second spatial light modulator, spatial light modulator, can be formed by a reflective spatial light modulator. However, it is also possible for at least one, a plurality or each of the components of first spatial light modulator, second spatial light modulator, spatial light modulator, to be formed by a transmissive spatial light modulator.

By way of example, at least one, a plurality or each of the components of first spatial light modulator, second spatial light modulator, spatial light modulator, can be formed by one or more of the following components: DMD (Digital Mirror Device), nematic SLM, LCOS display (LCOS=Liquid Crystal on Silicon), variable phase plate, controllable deformable mirror (DM).

The grating which is present according to the invention and which is represented on the second spatial light modulator serves in particular for removing a light portion which is incident on the second spatial light modulator outside the desired illumination region. Light diffracted at this grating is incident at the latest in the back focal plane of the microscope objective outside a region in which arriving light is guided or propagated as far as the sample by the microscope objective.

The grating used to control the second spatial light modulator for the purpose of removing unwanted light portions can in principle be an amplitude grating, i.e. be generated using an amplitude-modulating light modulator. Owing to the lower light losses, however, it is preferred if this grating is a phase grating, hence is generated using a phase-modulating light modulator.

The grating used to control the second spatial light modulator for the purpose of removing unwanted light portions is preferably a binary grating. The control of the second spatial light modulator then proves to be simple. However, it is also possible to use gratings which contain spatial frequencies only up to a maximum spatial frequency.

The grating used to control the second spatial light modulator for the purpose of removing unwanted light portions can be a blazed grating. Blazed gratings can also be referred to as blaze gratings.

The grating used to control the second spatial light modulator for the purpose of removing unwanted light portions can be a one-dimensional grating or a two-dimensional grating.

In principle, it is possible for the second spatial light modulator to be arranged in an intermediate image plane provided by a tube lens. Such a set-up is particularly compact, especially if moreover the first spatial light modulator and the second spatial light modulator are also provided by a first and a second sub-region of one and the same light modulator. A higher flexibility and more possibilities with regard to different microscopy methods are attained, however, if a relay optical unit providing an additional pupil plane and an additional intermediate image plane is present in the illumination beam path. The relay optical unit is preferably a 4f relay optical unit. The further pupil plane and further intermediate image plane provided by the relay optical unit can be used for manipulations of the excitation light. By way of example, the second spatial light modulator can be arranged in the additional intermediate image plane.

The diffraction efficiency of spatial light modulators is generally not 100%. Non-diffracted light can lead to disturbing artefacts in the sample plane, such as for example a constant intensity background. For the purpose of removing non-diffracted excitation light, i.e. excitation light of the zero order of diffraction, it is advantageously possible, in a pupil plane or in the vicinity of a pupil plane of the illumination beam path, to arrange a spatial high-pass filter in the region of the optical axis. In principle, this high-pass filter could be arranged in the back focal plane of the microscope objective. This is not possible, however, if the back focal plane lies within the microscope objective, this often being the case. In this case, the spatial high-pass filter can advantageously be positioned in the additional pupil plane provided by the relay optical unit. The high-pass filter can be for example an opaque point stop on the optical axis in a pupil plane.

Excitation light that is not diffracted by the first spatial light modulator in the pupil plane is incident on the tube lens as a collimated beam again and is focused to a point in the centre of the pupil by said tube lens. Excitation light that is diffracted by the first spatial light modulator has portions in the centre of the pupil, but these portions can be removed without any problems by the aforementioned high-pass filter, in particular by the aforementioned opaque stop, on the optical axis. Excitation light that reaches the second spatial light modulator in a collimated fashion and is not diffracted at this modulator can likewise be removed by the high-pass filter.

For the purpose of varying a spatial cut-off frequency of the spatial high-pass filter, a changer device, for example a filter wheel, can advantageously be present for the purpose of introducing different spatial filters into a pupil plane or into the vicinity of a pupil plane of the illumination beam path. Such a changer device can advantageously likewise be arranged in the additional pupil plane provided by a relay optical unit.

In principle, it would also be possible to realize different high-pass filters by means of a further amplitude-modulating spatial light modulator in the additional pupil plane.

The intermediate image plane provided by the relay optical unit can be used to arrange there a wavefront manipulator for correcting quadratic phase terms of the excitation light, for example a glass lens. This will be described in detail further below. Alternatively or additionally, a field stop could also be arranged in the intermediate image plane.

A particularly space-saving arrangement of the optical components is possible if excitation light coming from the first spatial light modulator is guided onto the second spatial light modulator via a mirror. This can be realized in particular advantageously in variants in which the first and second spatial light modulators are formed by a first and a second sub-region of one and the same spatial light modulator. The mirror can be a concave mirror in this case. In order to achieve the effect that the first light modulator is situated in a pupil plane of the illumination beam path, the first and second spatial light modulators can expediently be arranged at a distance from the concave mirror which corresponds in each case to the focal length of the concave mirror.

In principle, however, it is also possible for a lens to be arranged between the first spatial light modulator and the second spatial light modulator, which lens ensures that the plane in which the first spatial light modulator is situated is a pupil plane. In one advantageous configuration of the microscope according to the invention, the controller is configured to control the first spatial light modulator for the purpose of representing a virtual lens. In this exemplary embodiment, the lens which ensures that the first spatial light modulator is situated in a pupil plane is provided by the first spatial light modulator itself.

Virtual lens denotes a phase pattern which, represented on an SLM, leads to the focusing of the incident laser light. The phase pattern has the form of a Fresnel lens and is mathematically described by the following formula for a thin lens:

$$φ ( r ) = \frac{{k}_{0}}{2 f} \cdot {r}^{2} mod 2 π$$

wherein k₀=2π/λ₀, λ₀ is the wavelength of the laser, f is the focal length of the virtual lens, r is the radial spatial coordinate of the spatial light modulator and mod is the modulo operator. A virtual lens and a stop in the pupil plane can be used to remove the disturbing zero order of the undiffracted light [Poz15, Agh21]. 13 20 A focal length of the virtual lens is advantageously chosen such that the second spatial light modulator lies in a focal plane of the virtual lens.

If the first spatial light modulator is controlled for the purpose of representing a lens having a positive focal length, it is advantageous if a wavefront manipulator is arranged and/or formed in at least one intermediate image plane or in the vicinity of at least one intermediate image plane of the illumination beam path for the purpose of compensating for distortions of the wavefront of the excitation light that are caused by the first spatial light modulator. The distortions of the wavefront that are to be compensated for are quadratic phase terms of the excitation light in coordinates of the lateral spatial directions x, y, in particular. In this case, an axial spatial direction z is given by an optical axis of the illumination beam path and the two lateral spatial directions are the two spatial directions that are perpendicular to one another and to the direction of the axial spatial direction. The at least one wavefront manipulator can preferably have a positive focal length.

By way of example, a lens, for example a glass lens or an adjustable adaptive lens, having a positive focal length can be arranged in an intermediate image plane or in the vicinity of an intermediate image plane of the illumination beam path for the purpose of compensating of quadratic phase terms of the excitation light in coordinates of the lateral spatial directions x, y. For the purpose of optionally inserting or removing the glass lens into or from the illumination beam path at the location of the intermediate image plane, a changer device, for example with a suitable mechanical displacement or pivoting device, can be present. Removing the glass lens from the illumination beam path is expedient or necessary if no lens is represented on the first spatial light modulator. The wavefront manipulator, for example the glass lens, can advantageously be positioned in an intermediate image plane provided by a relay optical unit.

Supplementarily or alternatively, the wavefront manipulator can have one or more of the following components or can be realized partially or completely by one or more of the following components: adjustable lens having a positive focal length, Fresnel lens. The changer device can also have a plurality of glass lenses of varying focal length and one of the glass lenses can in each case be inserted into the intermediate image plane or in the vicinity of the intermediate image plane by the changer device. If an adjustable lens is used as a wavefront manipulator for the purpose of compensating for the quadratic phase, it is advantageous if the adjustable lens is adjustable to a neutral position. The neutral position of the adjustable lens can expediently be adjusted if no lens is represented by the first spatial light modulator in the pupil plane. Supplementarily or alternatively, it is also possible for the controller to be configured to control the second spatial light manipulator for the purpose of compensating for the quadratic phase for the purpose of at least partially realizing a Fresnel lens.

Depending on how the first spatial light modulator and the second spatial light modulator are controlled in order to configure the excitation light, the present invention enables various microscopy methods to be realized.

In a first variant, for the purpose of providing a widefield illumination on the first spatial light modulator and the second spatial light modulator at least in sub-regions it is possible to represent a constant phase pattern in each case. By way of example, at least in sub-regions all pixels of the first spatial light modulator and of the second spatial light modulator can be set to a constant phase or to a phase of zero.

In a further preferred variant of the method according to the invention, a one-dimensional or two-dimensional blazed grating is represented on the second spatial light modulator, the period of said grating being chosen such that excitation light of the first order of diffraction lies in an objective pupil in a TIRF region (TIRF=Total Internal Reflection Fluorescence). The TIRF region in the objective pupil is distinguished by the fact that light beams incident parallel to the optical axis there are radiated onto the sample at an angle which is greater than the angle for total internal reflection. The TIRF region is thus formed by an annulus having a specific minimum internal radius in the objective pupil. TIRF microscopy is particularly surface-sensitive.

Yet another advantageous variant of the method according to the invention is distinguished by the fact that a phase pattern of a one-dimensional or two-dimensional point grating which has a phase deviation of IT is represented on the second spatial light modulator, that the phase pattern is temporally sequentially shifted on the second spatial light modulator, and that the images recorded with in each case differently shifted point gratings are computed to form an image of the sample.

Such methods are known as SIM methods (SIM=Structured Illumination Microscopy). The phase pattern of a 1D line grating can consist of periodically alternating regions on the second spatial light modulator with a phase deviation of 0 or π. The phase pattern of a 2D point grating can be a chequered pattern in which the fields alternately have a phase deviation of 0 or π. The two phase patterns generate in the objective pupil orders of diffraction which correspond to a 1D or 2D SIM point grating in the object space. If the phase patterns are represented in a manner temporally sequentially shifted on the second spatial light modulator, then there is also a shift in the SIM point gratings in the sample and images with shifted point gratings can be recorded and subsequently computed. SIM methods are also possible with incidence of the excitation light in such a way that the TIRF condition is satisfied. Such methods are also referred to as TIRF-SIM methods. For the purpose of shifting the SIM pattern, a manipulation optical unit, for example a wobble plate, can be arranged in an intermediate image plane. This is described for example in DE 10 2022 103 051 A1. The wobble plate and a wavefront manipulator for correcting a quadratic phase, for example a field lens, can be mounted on a changer and be selectively introduced into the beam path.

Yet another advantageous variant of the method according to the invention is distinguished by the fact that a two-dimensional blazed-grating phase grating having an amplitude of 2π is represented on the second spatial light modulator in a region in which an illumination of the sample is desired, the period of this blazed-grating phase grating being chosen such that excitation light of the first order of diffraction is directed past a spatial high-pass filter arranged in a pupil plane or in the vicinity of a pupil plane, but lies within the pupil in the back focal plane of the microscope objective. The regions in which an illumination of the sample is desired are also referred to as ROIs (ROI=Region Of Interest). The high-pass filter could once again be a circular disc-shaped non-transparent region on the optical axis in a pupil plane.

In regions which are not intended to be imaged into the sample, the blazed-grating phase grating can be set to zero. These regions are not diffracted and they lie in the pupil plane on the non-transparent region. Optionally, in this method, a comparatively high proportion of the excitation light is not used since excitation light reaches the sample only in those regions in which an illumination of the sample is desired.

The device according to the invention makes it possible to represent any desired ROIs both with regard to location and with regard to shape and intensity, and the control patterns required in each case for the first spatial light modulator can be calculated with the aid of the Gerchberg-Saxton algorithm, for example. The control patterns calculated in this way can be added to the phase pattern required for representing a virtual lens and the new phase function that arises in this way can be represented by the first spatial light modulator. The virtual lens then carries out a Fourier transformation in such a way that the desired illumination pattern arises in the plane of the second spatial light modulator. An essential advantage of this method is that the light is only redistributed with the aid of phase-modulating light modulators and, therefore, almost all of the available excitation light is used.

Also possible are microscopy methods in which at least one two-dimensional blazed grating is represented on the first spatial light modulator, periods of the two-dimensional blazed grating being chosen so as to attain a single-spot illumination or a multi-spot illumination in an intermediate image plane.

For these method variants, a virtual lens is once again represented on the first spatial light modulator, the focal length of which virtual lens is chosen such that the focus lies on the second spatial light modulator. This virtual lens generates, in the plane of the second spatial light modulator, a Fourier transformation of the electric field in the plane of the first spatial light modulator. The quadratic phase generated by the virtual lens in the plane of the second spatial light modulator can be compensated for, as described above, for example with a glass lens in an intermediate image plane, hence with a field lens having a positive focal length.

Furthermore, multi-spot illumination methods are also possible, i.e. such methods in which the sample is illuminated by a plurality of focal spots, focal points or focal volumes, which are then moved over or through the sample by suitable control of the spatial light modulators. The positions of the individual points in the intermediate image can be adjusted by a two-dimensional blazed grating. Representing a plurality of points merely necessitates vectorially adding the electric fields of the individual points, extracting the phases of the entire electric field and adding the resulting phase pattern to the phase pattern of the virtual lens.

Finally, the first spatial light modulator in the pupil plane can advantageously be controlled for the purpose of correcting aberrations caused by optical components of the microscope and/or by the sample. It is thereby possible to react flexibly to deteriorations of the optical imaging quality of the microscope on account of system-dictated aberrations, for example defects or deformations of the spatial light modulators used, or aberrations which are caused by different samples. For such a correction of aberrations, the first spatial light modulator can be controlled e.g. using a suitable linear combination of Zernike modes. Owing to the capability of linear superposition of the individual contributions to the electromagnetic fields, this correction of aberrations can also be carried out if the first spatial light modulator is used principally for a different illumination method. Further advantages and features of the invention are explained below with reference to the figures, in which:

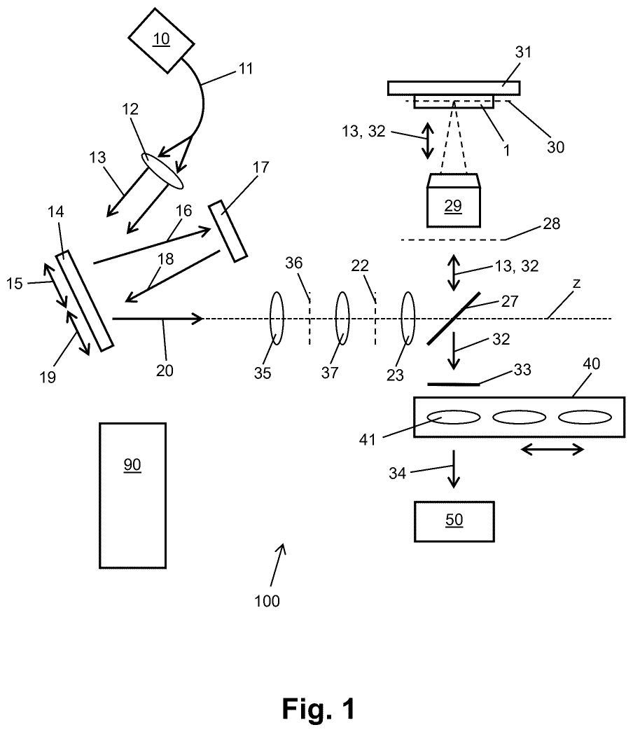

FIG. 1: shows a schematic illustration of one exemplary embodiment of a microscope according to the invention;

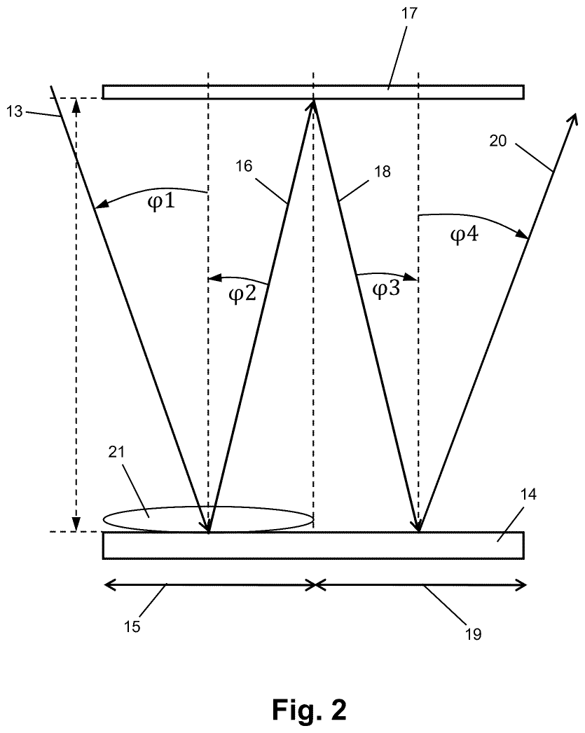

FIG. 2: shows a schematic illustration of a detail of the microscope from FIG. 1; and

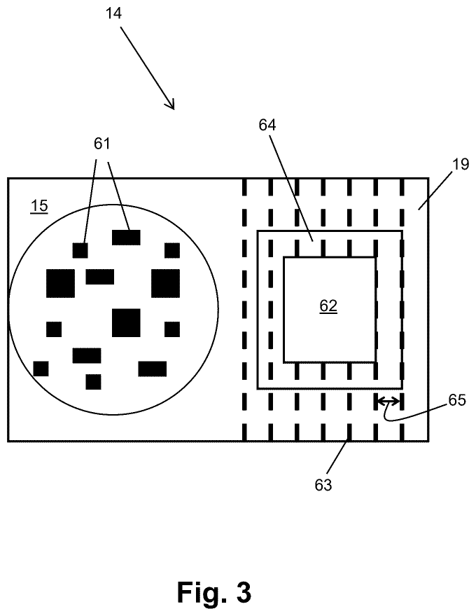

FIG. 3: shows further details of the microscope from FIG. 1 for elucidating the method according to the invention.

Identical and identically acting components are generally provided with the same reference signs in the figures.

One exemplary embodiment of a multimodal microscope 100 according to the invention will be described with reference to FIGS. 1 to 3. The multimodal microscope 100 shown schematically in FIG. 1 serves for examining a sample 1 and has firstly a light source 10 for transmitting excitation light 13 and an illumination beam path for guiding the excitation light 13 onto the sample 1 to be examined. For the purpose of manipulating the excitation light 13, the illumination beam path has a first spatial light modulator 15 and a second spatial light modulator 19. According to the invention, the first spatial light modulator 15 is arranged in or near a pupil plane of the illumination beam path and, according to the invention, the second spatial light modulator 19 is arranged in or near an intermediate image plane of the illumination beam path downstream of the pupil plane.

For the purpose of controlling at least the first spatial light modulator 15 and the second spatial light modulator 19, a controller 90, for example a PC, is present according to the invention, said controller being configured to control the first spatial light modulator 15 and/or the second spatial light modulator 19 for the purpose of realizing different illumination modes for the sample (1).

In the exemplary embodiment shown, the first spatial light modulator 15 and the second spatial light modulator 19 are formed as a first sub-region and second sub-region, respectively, of one and the same reflective spatial light modulator 14, which can be for example a phase-modulating SLM, for example an LCOS display.

Finally, a component part according to the invention of the illumination beam path is a microscope objective 29. In the exemplary embodiment shown, the illumination beam path additionally has a mirror 17, a relay optical unit having lenses 35 and 37, a tube lens 23 and a main beam splitter 27. The relay optical unit 35, 37 images an intermediate image plane 22 into that plane in which the second spatial light modulator 19 is arranged. The tube lens 23 and the lens 37 of the relay optical unit image a back focal plane 28 into a pupil plane 36 formed between the lenses 35 and 37. The mirror 17 can be a plane mirror. Alternatively, the mirror 17 can also be a concave mirror, which together with the lens 35 and optionally together with a virtual lens represented on the first spatial light modulator images the pupil plane 36 into the plane of the light modulator of the first spatial light modulator 15. Details in respect thereof will be explained further below in association with FIG. 2.

Detection light 32 emitted by the sample 1 owing to illumination with the excitation light 13 is detected by a detector 50 present according to the invention. In the exemplary embodiment shown, the detector 50 can be a camera, i.e. a pixelated two-dimensionally spatially resolving detector. However, that is not mandatory. It is also possible to use detectors which consist of a single pixel, for example photomultipliers or SPADs, or of a line array of pixels, for example a CMOS, CCD or SPAD line array. According to the invention, the detection light 32 is guided onto the detector 50 via a detection beam path. In the exemplary embodiment shown, the microscope objective 29 is part of the detection beam path. However, that is not mandatory. The detection beam path can also have a separate microscope objective. In the exemplary embodiment shown, the detection beam path additionally has the main beam splitter 27, and emission filter 33 and a tube lens 41. For microscopic techniques in which detection light 32 is fluorescent light which is red-shifted in comparison with the excitation light 13, i.e. has a longer wavelength, the main beam splitter 27 can be a dichroic beam splitter. The detector 50 can be situated in an intermediate image plane of the detection beam path, in particular. For the purpose of introducing different tube lenses into the detection beam path, a lens changer 40, for example a linear changer, is present.

The controller 90 can also serve for controlling further components of the microscope 100 and for evaluating measurement data of the camera 50. The controller 90 is operatively connected to the components which it serves to control and whose measurement data it evaluates, the connection being effected by cables, for example, which are not illustrated in the figure.

According to the invention, in the case of the microscope 100 in FIG. 1, the controller 90 is also configured to control the second spatial light modulator 19 outside a desired illumination region for the purpose of representing a grating 63, the period 65 of which is chosen such that excitation light of the +1st and/or −1st order of diffraction lies outside a pupil in the back focal plane 28 of the microscope objective 29. Details in respect thereof will be explained further below in association with FIG. 3.

The excitation light 13 from the light source 10 passes via an optical fibre 11 firstly to a lens 12, which serves for collimating the excitation light 13. As shown in FIG. 2, the collimated beam of the excitation light 13 is then incident on the first spatial light modulator 15 at an angle of φ1 relative to the normal direction and is reflected by said modulator in the direction of the mirror 17, optionally after manipulation by the first spatial light modulator 15, as light beam 16 having an angle of φ2 relative to the normal direction. In regions in which a constant phase is set on the first spatial light modulator 15, the angle of incidence φ1 is equal to the angle of reflection φ2. The mirror 17 reflects the excitation light as light beam 18 back in the direction of the second spatial light modulator 19, on which the light beam 18 is incident at an angle of φ3 relative to the normal direction. According to the invention, further manipulations of the excitation light take place at the second spatial light modulator 19, said excitation light being reflected by the second spatial light modulator 19 as light beam 20 and at an angle of φ4 relative to the normal direction. In regions in which a constant phase is set on the second spatial light modulator 19, the angle of incidence φ3 is once again equal to the angle of reflection φ4.

On account of its positioning in the illumination beam path, the second spatial light modulator 19 is situated in an intermediate image plane. In order then to achieve the effect that the first spatial light modulator 15, as required, is situated in a pupil plane, there are a number of possibilities. Firstly, the mirror 17 can be a concave mirror, which is arranged and the focal length of which is chosen such that collimated beams of rays coming from the first spatial light modulator 15 are focused onto the second spatial light modulator 19. Another possibility for achieving the effect that the first spatial light modulator 15 is situated in a pupil plane consists in representing a virtual lens 21, which is indicated schematically in FIG. 2, on the first spatial light modulator 15 by means of suitable control. Also possible are combinations in which the mirror 17 and the virtual lens 21 each make a contribution to the first spatial light modulator 15 being situated in a pupil plane.

If the first spatial light modulator 15 is controlled for the purpose of representing a virtual lens, it is expedient and possibly necessary, as described in detail above, to compensate for quadratic phase terms in the lateral coordinates x, y by means of a lens having a positive focal length that is arranged in an intermediate image plane, for example in the intermediate image plane 22.

The excitation light 13, 20 coming from the second spatial light modulator 19 then passes via the relay optical unit 35, 37 and the tube lens 23 to the main beam splitter 27 and is guided by the latter in the direction of the microscope objective 29, which guides, for example focuses, the excitation light 13 into a sample plane 30 in the sample 1. A sample holder 31 serves for holding the sample 1.

The generation and mode of operation of a grating 63 for removing undesired light portions are explained below with reference to FIG. 3.

FIG. 3 schematically shows the spatial light modulator 14 from FIGS. 1 and 2. FIG. 3 illustrates on the left the first spatial light modulator 15, which is situated in a pupil plane, and schematically illustrates on the right-hand side the second light modulator 19, which is situated in an intermediate image plane.

Structures 61 are illustrated schematically in the first spatial light modulator 15, which structures are intended to clarify a phase pattern which serves to illuminate a region 62 for example with a constant intensity of the excitation light 13 in the plane of the second spatial light modulator 19, i.e. in an intermediate image plane and thus in the sample. The phase pattern with which the first spatial light modulator 15 is to be controlled for this purpose can be calculated using a Gerchberg-Saxton algorithm, for example.

Inaccuracies in the optical set-up and in the calibration of the first spatial light modulator 15, and/or other inaccuracies, in particular discretization errors, when generating and representing the phase pattern 61 used to control the first spatial light modulator 15 can have the effect that a portion of the excitation light 13 coming from the first spatial light manipulator 15 is incident on the second spatial light modulator 19 outside the intended region 62. In the situation illustrated in FIG. 3, for example, the region 64 adjacent to the region 62 actually to be illuminated is likewise impinged on by excitation light 13, although this is not desirable there.

The present invention combats such inaccuracies by virtue of a grating 63 being represented by means of the second spatial light modulator 19 in the regions outside the intended illumination region 62, the period 65 of which grating is chosen such that the excitation light diffracted at this grating 63 cannot be propagated as far as the sample by the further illumination beam path. The period 65 is thus permitted to have at most a certain maximum value in order to achieve the effect that the excitation light 13 diffracted at the grating 63 does not pass through the back focal plane of the objective 29 or a pupil plane in the illumination beam path upstream thereof. If for any reason it is preferred for unwanted excitation light 13 not to advance as far as the back focal plane of the objective 29 from the outset, in the set-up in FIG. 1, a pinhole stop of suitable size could be arranged in the pupil plane 36 or a further spatial light modulator arranged in this pupil plane could be used to represent such a pinhole stop, for example in addition to a punctiform or circular disc-shaped stop having a small diameter on the optical axis for the purpose of blocking out non-diffracted excitation light. The pinhole stop could also be a point stop having two opaque points. The two opaque points preferably lie at the position of the −1st and +1st orders of the grating. In the exemplary embodiment shown schematically in FIG. 3, the grating 63 is a binary one-dimensional phase grating. However, that is not mandatory. The grating could also be a two-dimensional grating and/or an amplitude grating.

The present invention provides a multimodal microscope and a method in which, using spatial light modulators in a pupil plane and an intermediate image plane, the excitation light can both be manipulated to form, in principle, any desired illumination patterns, including the manipulation of individual points, and be suitably conditioned for the purpose of TIRF microscopy, SIM microscopy or laser widefield illumination. Skillful control of the spatial light modulators enables various microscope modes to be implemented, in many cases without the need to make apparatus-related changes, for example in the illumination beam path itself.

### LIST OF REFERENCE SIGNS

1 sample
10 light source
11 optical fibre
12 lens, collimation lens
13 excitation light
14 spatial light modulator, phase modulator
15 first sub-region of the phase modulator 14, first spatial light modulator
16 excitation light 13 reflected back and optionally manipulated by the first spatial light modulator 15
17 mirror or concave mirror
18 excitation light 13 reflected in the direction of the second spatial light modulator 19 by the mirror 17
19 second sub-region of the phase modulator 14, second spatial light modulator
20 excitation light 13 reflected back and optionally manipulated by the second spatial light modulator 19
21 virtual lens, represented by the first spatial light modulator 15
22 intermediate image plane
23 tube lens
27 main beam splitter
28 back focal plane of the microscope objective 29
29 microscope objective
30 sample plane, image plane, focal plane of the microscope objective 29
31 sample holder
32 detection light, light emitted or reflected back by sample 1 owing to irradiation with excitation light 13
33 emission filter
34 filtered detection light
35 lens, forms 4f relay with lens 37
36 pupil plane
37 lens, forms 4f relay with lens 35
40 changer device for tube lens in the detection beam path
41 tube lens in the detection beam path
50 detector, camera
61 phase pattern, for example generated using Gerchberg-Saxton algorithm
62 region to be illuminated in the intermediate image plane and thus the sample plane 30
63 grating for removing stray light
64 region in which stray light appears in an intermediate image plane
65 spatial period of grating 63

### REFERENCES

[Cla16] “Comparison of beam generation techniques using a phase only spatial light modulator”, Opt. Expr. 24/6, 6249, 2016
[Dav99] “Encoding amplitude information onto phase-only filters”, Appl. Opt. 38/23, 5004, 1999
[Ger72] “A Practical Algorithm for the Determination of Phase from Image and Diffraction Plane Pictures”, Optik Vol. 35, No. 2 (1972)
[Jes08] “Near-perfect hologram reconstruction with a spatial light modulator”, Opt. Expr. 16/4, 2597, 2008
[Nak19] “Utilization of the high spatial frequency component in adaptive beam shaping by using a virtual diagonal phase grating”, Sci. Rep. 9, 4690, 2019
[RAPP0] https://rapp-opto.com/[Rei99] “Optical particle trapping with computer-generated holograms written on a liquid-crystal display”, Opt. Lett. 24/9, 608, 1999
[Sim14] “Development of a doubly weighted Gerchberg-Saxton algorithm for use in multibeam imaging applications”, Opt. Lett. 39/8, 2431, 2014
[US001] U.S. Pat. No. 9,778,573 B

1. Multimodal microscope comprising:
a light source for transmitting excitation light,
an illumination beam path with a microscope objective for guiding the excitation light onto and/or into a sample to be examined,
a detector for detecting detection light emitted by the sample owing to illumination with the excitation light,
a detection beam path, comprising the microscope objective or a further microscope objective, for guiding the detection light onto the detector,
in the illumination beam path a first spatial light modulator being arranged in or near a pupil plane of the illumination beam path and a second spatial light modulator being arranged in or near an intermediate image plane of the illumination beam path downstream of the pupil plane,
a controller at least for controlling the first spatial light modulator and the second spatial light modulator, said controller being configured to control the first spatial light modulator and/or the second spatial light modulator for realizing an illumination mode for the sample,
wherein the controller is configured to control the second spatial light modulator outside a desired illumination region for representing a grating, the period of which is chosen such that excitation light of the +1st and/or of the −1st order of diffraction lies in at least one pupil plane outside a region through which there is propagation as far as the sample.

2. Microscope according to claim 1,
wherein the grating is at least one of: a phase grating and/or an amplitude grating; a binary grating; or a one-dimensional or a two-dimensional grating.

3. (canceled)

5. Microscope according to claim 1,
wherein the first spatial light modulator is formed by a first sub-region of a spatial light modulator, and wherein the second spatial light modulator is formed by a second sub-region of the same spatial light modulator.

6. Microscope according to claim 1,
wherein at least one, a plurality or each of the components of first spatial light modulator, second spatial light modulator, light modulator, is or are formed by a phase-modulating spatial light modulator.

7. Microscope according to claim 1,
further comprising a relay optical unit providing an additional pupil plane and an additional intermediate image plane in the illumination beam path, wherein the second spatial light modulator is arranged in the additional intermediate image plane.

8. (canceled)

9. Microscope according to claim 1,
wherein a spatial high-pass filter is arranged in a pupil plane or in the vicinity of a pupil plane of the illumination beam path.

10. Microscope according to claim 1,
further comprising a changer device for introducing different spatial filters into a pupil plane or into the vicinity of a pupil plane of the illumination beam path.

11. Microscope according to claim 1,
wherein excitation light coming from the first spatial light modulator is guided onto the second spatial light modulator via a mirror.

12. Microscope according to claim 1,
wherein the controller is configured to control the first spatial light modulator for representing a virtual lens.

13. Microscope according to claim 12,
wherein the second spatial light modulator lies in a focal plane of the virtual lens.

14. Microscope according to claim 12,
wherein a wavefront manipulator having a positive focal length is arranged in at least one intermediate image plane or in the vicinity of at least one intermediate image plane of the illumination beam path for compensating quadratic phase terms of the excitation light in coordinates of the lateral spatial directions.

15. Microscope according to claim 14,
wherein the wavefront manipulator has one or more of the following components or is realized partially or completely by one or more of the following components: glass lens having a positive focal length, adjustable lens having a positive focal length, Fresnel lens.

16. Microscope according to claim 14,
wherein the controller is configured to control the second spatial light manipulator for at least partially realizing a Fresnel lens.

17. Microscope according to claim 14,
wherein the changer device has a plurality of glass lenses of varying focal length, and wherein one of the glass lenses is in each case insertable into the intermediate image plane or in the vicinity of the intermediate image plane by the changer device.

18. Method for microscopy, the method comprising:
guiding excitation light onto and/or into a sample to be examined, via an illumination beam path with a microscope objective, guiding detection light emitted by the sample owing to illumination with the excitation light onto a detector via the microscope objective or a further microscope objective, detecting the detection light by said detector,
the excitation light is guided via a first spatial light modulator arranged in or near a pupil plane of the illumination beam path and subsequently via a second spatial light modulator arranged in or near an intermediate image plane of the illumination beam path downstream of the pupil plane, and the excitation light is modulated by the first and/or the second spatial light modulator for realizing an illumination mode for the sample,
wherein the second spatial light modulator is controlled outside a desired illumination region for representing a grating, the period of which is chosen such that light of the +1st and/or of the −1st order of diffraction lies in at least one pupil plane outside a region through which there is propagation as far as the sample.

19. Method according to claim 18,
wherein excitation light of the zero order of diffraction is filtered by a spatial high-pass filter on the optical axis in a pupil plane or in the vicinity of a pupil plane.

20. Method according to claim 18,
wherein the first spatial light modulator represents a virtual lens, the focal length of which is chosen such that the focus lies on the second spatial light modulator.

21. Method according to claim 18,
wherein the first spatial light modulator in the pupil plane is controlled for correcting aberrations caused by optical components of the microscope and/or by the sample.

22. Method according to claim 18,
wherein at least one two-dimensional blazed grating is represented on the first spatial light modulator, periods of the two-dimensional blazed grating being chosen so as to attain a single-spot illumination or a multi-spot illumination in an intermediate image plane.

23. Method according to claim 18,
wherein a two-dimensional blazed-grating phase grating having an amplitude of 2π is represented on the second spatial light modulator in a region in which an illumination of the sample is desired, the period of this blazed-grating phase grating being chosen such that excitation light of the first order of diffraction is directed past a spatial high-pass filter arranged in a pupil plane or in the vicinity of a pupil plane, but lies within the pupil in the back focal plane of the microscope objective.

24. Method according to claim 18,
wherein a phase pattern of a one-dimensional or two-dimensional point grating which has a phase deviation of IT is represented on the second spatial light modulator,
wherein the phase pattern is temporally sequentially shifted on the second spatial light modulator, and
wherein the images recorded with in each case differently shifted point gratings are computed to form an image of the sample.

25. Method according to claim 18,
wherein a one-dimensional or two-dimensional blazed grating is represented on the second spatial light modulator, the period of said grating being chosen such that excitation light of the first order of diffraction lies in an objective pupil in a TIRF region.

26. Method according to claim 18,
wherein a constant phase pattern is represented on the first spatial light modulator and the second spatial light modulator for providing a widefield illumination at least in sub-regions.

27. Method according to claim 26,
wherein at least in sub-regions all pixels of the first spatial light modulator and of the second spatial light modulator are set to a constant phase or to a phase of zero.
